(19) United States
(12) Patent Application Publication
(10) Pub. No.: US 2003/0191212 A1
(43) Pub. Date: Oct. 9, 2003

(54) Asphalt improving material which comprising specific composition, improved asphalt mixture and its pavement method, and composition

(76) Inventors: Hiroshi Yamazaki, Osaka (JP); Masatoshi Yoshida, Nara-shi (JP)

Correspondence Address: CONNOLLY BOVE LODGE & HUTZ LLP, SUITE 800, 1990 M STREET NW, WASHINGTON, DC, 20036-3425, US

(21) Appl. No.: 10/114,060

(22) Filed: Apr. 3, 2002

(51) Int. Cl. C08J 3/00

(52) U.S. Cl. 524/59

(57) ABSTRACT

It is an object to provide asphalt modifier, modified asphalt and modified asphalt mixture capable of preventing phase separation of asphalt from the modifier, capable of improving the toughness and tenacity of asphalt and increasing the adhesion thereof to aggregates to thereby offer improved durability, without impairing the workability or increasing the cost of production

and a pavement method of modified asphalt as well as a composition comprising a styrenic elastomer and a (meth)acrylic resin.

It is an asphalt modifier

which comprises an elastomer and a (meth)acrylic resin as essential constituents,

with the ratio of said (meth)acrylic resin being 0.01 to 1.5 parts by weight per 1.0 part by weight of said elastomer.

### TECHNICAL FIELD

The present invention relates to an asphalt modifier, modified asphalt, modified asphalt mixture and its pavement method as well as a composition comprising a styrenic elastomer and a (meth)acrylic resin.

### BACKGROUND ART

Asphalt is a mixture of naphthenes, aromatic hydrocarbons, polycyclic aromatic hydrocarbons, asphaltenes and so on. It is mixed, by kneading, with an aggregate and other additives, and the resulting asphalt mixture is used mainly as a pavement material or the like. The asphalt species generally used are straight asphalt, blown asphalt and semi-blown asphalt. Due to the recent increases in the volume of traffic, in particular in the number of heavyweight vehicles, asphalt-paved roads are now used under serious conditions. In the asphalt-paved roads paved with these asphalt species, the asphalt pavement surface in heavyweight vehicle lanes or inflow points of intersection undergoes deformation and, thus, the so-called flow phenomenon, such as rut or corrugation, occurs. From the traffic safety viewpoint, this is a problem that cannot be ignored, since it may cause water splashing over oncoming cars or walkers, loss of steering wheel control, reduced antiskidding effect, impaired comfortableness of running, etc.

One of the conceivable measures to prevent this flow phenomenon is to modify asphalt so as to increase its mechanical strength, for example the toughness (holding power), and thereby prevent its deformation. To add a rubber or thermoplastic resin to asphalt is considered as one of the effective methods of improving the mechanical properties of asphalt to thereby reduce the flow thereof. For example, there are type I modified asphalt prepared by adding a styrene-butadiene rubber (SBR) or the like, type II modified asphalt prepared by adding a styrene-butadiene-styrene elastomer (SBS) or the like, and high-viscosity modified asphalt prepared by adding a large amount of SBS or the like.

However, for improving the toughness of asphalt to a sufficient level by adding a rubber or thermoplastic resin, it is necessary to use the rubber or resin in large amounts and this produces such problems as increased production cost, impaired workability due to increased asphalt viscosity, and tendency toward phase separation of asphalt and the modifier from each other. Further, although the mechanical strength is improved, the addition of such modifier is not very effective in improving the adhesion to aggregate, namely the adhesiveness of asphalt to aggregates.

Meanwhile, in summer, asphalt in asphalt pavements under water permeation and repeated loading by cars undergoes the so-called stripping phenomenon, namely the separation thereof from aggregates by means of water. Road surveys concerning such stripping have revealed that asphalt pavements showing a greater magnitude of flow phenomenon show an increasing tendency toward occurrence of the stripping phenomenon. Therefore, for providing modified asphalt with greater durability, it is important to improve not only the mechanical properties but also the adhesion to aggregates. In winter, the surface of asphalt-paved roads is worn by spiked tires. This phenomenon is similar to rut since the wear is caused at car's running area. This wear is close to abrasion, so that asphalt portions are worn earlier and crushed-stone pieces are exposed and become protruding. In inflow points of intersections, spikes dig up these protruding crushed stones and, when scattered, such crushed stones accelerate the wear sharply. It is thought that if the adhesion of modified asphalt to crushed stone can be improved, those troubles can be avoided as a result of occurrence of increased durability.

It is thus important to improve the adhesion to aggregates. Among the means so far investigated, there is method comprising adding specific organic compounds, such as silane compounds or surfactants, as stripping inhibitor. Thus, a method comprising adding aminoalkylsilane compounds is disclosed in Japanese Kokoku Publication Sho-51-44134. However, although the adhesion of modified asphalt to aggregates is improved by addition of silane compounds, the mechanical strength of modified asphalt will not be increased thereby. No matter how the adhesion to aggregates is improved, it is a matter of course that the pavement is deformed if the strength of modified asphalt itself is insufficient. It cannot but be said that the addition of these compounds provided only a slight extent of durability. Also disclosed, in Japanese Kokai Publication Sho-60-1260, is a method comprising using one of various elastomers, such as ethylene-ethyl acrylate copolymers and SBRs, and a silane compound combinedly. However, while the use of an elastomer brings about an improvement in mechanical strength, it is necessary to use the elastomer in large amounts to improve the toughness sufficiently, as mentioned above.

On the other hand, for increasing the mechanical strength, for example toughness, of asphalt, there is a technique comprising adding a modifier, such as a rubber or thermoplastic resin, in particular a styrenic elastomer, as mentioned above. Further, Japanese Kokai Publication Sho-59-1567 discloses a technique according to which a styrenic elastomer and a petroleum resin are combinedly used. However, this technique improves the mechanical strength, typically toughness, but cannot improve the adhesion to aggregates at all. Therefore, the use of asphalt modified by this technique result in a strong tendency toward stripping, since the adhesion to aggregates is not increased in spite of an increase, in responsive to the increase in toughness, in the stress caused upon deformation under a load. Thus, the technique is unsatisfactory in the effect of improving the durability of asphalt pavements.

In Japanese Kokai Publication Hei-03-31365 and Japanese Kokai Publication Hei-03-12456, there are disclosed methods of improving the elastic properties of bitumen which comprise adding a (meth)acrylate polymer as a modifier. These methods, however, cannot improve such physical properties as toughness and tenacity (caking property), although it is shown that such physical properties as elasticity recovery are improved to some extent. It cannot but be said that the physical properties are quite insufficient for the improved bitumen to be used in pavements currently required to have durability. Further, the technique disclosed in Japanese Kokai Publication Hei-03-31365, which uses a high-molecular-weight polymer, is disadvantageous in that the polymer is poor in compatibility with asphalt and this makes it difficult to use it as a modifier.

In Japanese Kokai Publication Hei-11-60961, there is disclosed an asphalt composition comprising asphalt, a high-molecular modifier, such as a natural rubber or styrene-butadiene random copolymer species, and an oily gelling agent. It is indicated that the high-molecular modifier comprises one or more selected from among those various polymers listed. In the above-cited reference, however, there is described no specific combination of two or more polymers to be used as high-molecular modifiers. In Japanese Kokai Publication Hei-09-235470, there is disclosed an asphalt modifier comprising a rubber type and/or resin type asphalt modifier and a phosphorus compound. In the above-cited reference, mixture of a styrenic elastomer (SBS or SIS) and a polyolefin resin (EEA or EVA) are given as examples but nothing is mentioned of other combinations. In the above-mentioned reference, no mention is made at mixing ratio of the rubber type modifier and resin type modifier.

Thus, in the prior art, there has already been room for contrivance for improving the characteristics of asphalt to be used in pavements. Further, in recent years, open-graded mixtures have attracted attention as asphalt mixtures for draining pavements. Thus, stronger adhesion to aggregates is required as compared with dense-graded mixtures used in the prior art. Such draining pavements are required to have high-level durability since they are intended to be improved so that the water splashing over oncoming cars or walkers or the loss of steering wheel control can be prevented, the antiskidding effect can be prevented from being reduced, and the comfortableness of running can be improved. Therefore, under such circumstances, the advent of an asphalt modifier capable of improving both the adhesion to aggregates and the toughness of asphalt has been earnestly awaited.

Styrenic elastomers, typically styrene-butadiene block copolymers such as styrene-butadiene-styrene triblock copolymers (SBSs) and styrene-butadiene diblock copolymers (SBs), are useful compounds excellent in flexibility, workability, physical properties in lower temperature and other characteristics and widely used as raw materials for the preparation of adhesives, pressure-sensitive adhesives, molding materials, resins and so on, and as modifiers for resins such as polyolefins and polystyrene as well as asphalt. Generally, however, they are poor in compatibility with other resins and, when they are used as asphalt modifiers, for instance, the problem is encountered that the heat stability of asphalt cannot be improved to a satisfactory extent. For the use thereof as adhesives or the like, they have a problem in that their adhesion to polyolefins or metals is poor.

Meanwhile, (meth)acrylic resins are excellent in transparency, weatherability and surface hardness, among others, and therefore used as materials for manufacturing various industrial products. If the (meth)acrylic resins having such properties can be compatibilized with styrenic elastomers, it may become possible to provide materials or modifiers capable of further providing the characteristics of styrenic elastomers in addition to the characteristics of (meth)acrylic resins. However, there is no 100% (meth)acrylic resin compatibilizable with styrenic elastomers such as SBSs.

As for the technology of improving the compatibility between different resins, a method which comprises adding a compatibilizer having affinity for both resins to be combined is generally used and, thus, process oils, petroleum resins and terpene resins, for instance, are used as compatibilizers for SBSs and asphalt. However, even when these compatibilizers are used, the improvement in compatibility is unsatisfactory. As for the compatibilizers capable of compatibilizing styrenic elastomers with (meth)acrylic resins, none is sufficiently effective. Currently in use as the means for compatibilizing (meth)acrylic resins with a styrene are the method comprising using an acrylic/styrenic copolymer and the method comprising grafting (meth)acrylic acid onto a styrenic resin.

As for the technology of improving the compatibility between different resins, Japanese Kokai Publication Hei-08-208920 discloses a composition comprising a compatible polymer mixture composed of an α-methylstyrol monomer-derived polymer and a cyclohexyl methacrylate-containing polymer, and Japanese Kokai Publication Hei-05-112685 discloses a compatible polymer mixture comprising a polystyrol having a specific structure and a polymethacrylate ester.

Japanese Kokai Publication Hei-07-292190 discloses a rubber-modified aromatic vinyl resin composition obtained by copolymerizing a mixed solution comprising one or more of (meth)acrylic acid higher alkyl ester monomers having a specific composition and, in Japanese Kokai Publication Hei-05-295216, there is disclosed a thermoplastic resin composition comprising specific weight ratios of an acrylic resin and (B): the hydrogenation product derived from a ternary block copolymer (thermoplastic block copolymer) having a specific structure including an aromatic vinyl monomer-derived block structure.

It is disclosed in Japanese Kokai Publication Hei-05-230322 that by adding a specific amount of a copolymer having units compatible with both a methacrylic resin and a hydrogenated block copolymer to a resin composition comprising the hydrogenated block copolymer and methacrylic resin, it is possible to improve the compatibility between both the hydrogenated block copolymer and methacrylic resin. In Japanese Kokai Publication Sho-58-26543, a highly transparent radical block copolymer mixture is disclosed which is essentially composed of two butadiene-styrene radical block copolymers and acrylic acid or a like polymerizable or copolymerizable substance.

However, even these technologies cannot improve the compatibility between styrenic elastomers, such as SBSs, and (meth)acrylic resins to a satisfactory extent. Thus, there is room for investigations to improve the compatibility therebetween to thereby rendering them applicable in various uses.

### SUMMARY OF THE INVENTION

In view of the foregoing, it is an object of the present invention to provide asphalt modifier, modified asphalt and modified asphalt mixture capable of preventing phase separation of asphalt from the modifier, capable of improving the toughness and tenacity of asphalt and increasing the adhesion thereof to aggregates to thereby offer improved durability, without impairing the workability or increasing the cost of production and a pavement method of modified asphalt as well as a composition comprising a styrenic elastomer and a (meth)acrylic resin.

The present invention provides an asphalt modifier which comprises an elastomer and a (meth)acrylic resin as essential constituents,

with the ratio of the (meth)acrylic resin being 0.01 to 1.5 parts by weight per 1.0 part by weight of the elastomer.

In the course of their investigations concerning various modified asphalt and like compositions, the present inventors encountered the fact that the toughness and tenacity of asphalt and, at the same time, the adhesion thereof to aggregates can be improved by using an elastomer and a specific resin, namely a (meth)acrylic resin, in specific ratios without using them in large amounts, whereby it becomes possible to form pavements excellent in durability, and thus dramatic effects can be produced accordingly, namely the phase separation of asphalt from the modifier can be prevented and the modified asphalt can suitably be applied to pavements required in recent years to have high-level durability, without the workability being impaired or the production cost being increased.

In the course of various investigations concerning the (meth)acrylic resin to be used in combination with styrenic elastomers, the present inventors also found that resins produced by polymerizing a monomer composition comprising, as essential constituents, a (meth)acrylate of which ester moiety has a cyclohexyl group and a (meth)acrylate of which ester moiety has an alkyl group containing not less than 8 carbon atoms, have sufficient compatibility with styrenic elastomers and are effective as compatibilizers therefor. It was further found that when such (meth)acrylic resins have a molecular weight in a specific range, they are preferred and can exhibit more satisfactory effects.

Further, it was found that when such (meth)acrylic resins are used in combination with styrenic elastomers, it becomes possible for the effects of the styrenic elastomers to be fully exhibited in various fields of applications and that, in compositions comprising such a styrenic elastomer and (meth)acrylic resin, the (meth)acrylic resin is compatible with both the styrenic elastomer and asphalt, so that the compositions, when used in modifying asphalt, can improve the heat stability of the modified asphalt and can produce such effect even when straight asphalt, with which SBSs are said to be most incompatible, is used. Furthermore, it was found that when the compositions are used in modifying polyolefins, polystyrene and like resins, the resins after modification can be improved in weatherability, adhesion, vibration damping property, impact resistance and so forth in addition to the effects of the styrenic elastomer and, further, that when they are used as pressure-sensitive adhesive compositions or adhesive compositions, the weatherability and adhesiveness, among others, can be improved. Thus, it was found that such (meth)acrylic resins can appropriately be used as compatibilizers for improving styrenic elastomers on the whole. These findings have now led to completion of the present invention.

### DETAILED DISCLOSURE OF THE INVENTION

In the following, the present invention is described in detail.

The asphalt modifier of the invention comprises an elastomer and a (meth)acrylic resin as essential constituents.

The term “elastomer” means a polymer or like high-molecular substance showing rubber elasticity in a specific temperature range. In the practice of the invention, an elastomer showing an elongation of not less than 600% at 23° C. as determined by tensile test according to JIS K 7113 “Testing Methods for Tensile Properties of Plastics”, for instance, is preferably used. Such an elastomer can give flexible extensibility to the modified asphalt and therefore can improve the tenacity of asphalt.

Suited for use as the above-mentioned elastomer are rubbers and thermoplastic elastomers (TPEs), the steric structure of which may be linear, branched, star-shaped, or grafted. Suitable species of such elastomers are styrenic elastomers such as styrene-butadiene rubbers (SBRs) and styrene-butadiene-styrene block polymers (SBSs); diene elastomers such as butadiene rubbers; olefinic elastomers such as ethylene-ethyl acrylate copolymers; chloroprene rubbers; and acrylic elastomers. These maybe used singly or two or more of them may be used in combination. Among these, SBSs are most suited for use in the practice of the invention from the viewpoint of solubility in asphalt and of mechanical properties.

As for the constituent ratios in the above-mentioned SBSs, it is preferred that when the total SBS-constituting monomer constituents are taken as 100% by weight, styrene accounts for 10 to 50% by weight. When the styrene content is less than 10% by weight, the cohesive force is weak, so that the strength of asphalt may not be improved to a satisfactory extent. When it exceeds 50% by weight, the SBS may possibly be hardly soluble in asphalt. A styrene content of 20 to 50% by weight is more preferred, and 20 to 40% by weight is still more preferred.

As for the molecular weight of the above-mentioned SBSs, it is preferred that they have a weight average molecular weight of 50,000 to 500,000. When it is less than 50,000, the cohesive force is weak, so that the strength of asphalt may not be improved to a satisfactory extent. When it exceeds 500,000, the SBSs may possibly be hardly soluble in asphalt. It is more preferably 100,000 to 500,000, still more preferably 150,000 to 400,000.

In the present description, the “weight average molecular weight” means the one determined by gel permeation chromatography (GPC) on the polystyrene equivalent basis using standard polystyrene species.

In the present description, the “(meth)acrylic resin” means a resin comprising polymer molecules formed by a monomer composition comprising a (meth)acrylic monomer(s). In the practice of the present invention, any such resin soluble in asphalt can be used and the resin may be variegated in physical properties according to the intended purpose. In view of the increased improving effects on the adhesion to aggregates and the toughness of modified asphalt, however, those compatible with asphalt are preferred. Further, preferably used are, for example, those (meth)acrylic resins which show an elongation less than 600%, more preferably less than 500%, still more preferably less than 400%, as measured at 23° C. in tensile test according to JIS K 7113 “Testing Methods for Tensile Properties of Plastics”. When such (meth)acrylic resins, which are rigid resins, are used, the toughness-improving effect on modified asphalt can be increased.

Further, the above-mentioned (meth)acrylic resin preferably has carboxyl groups. Thereby, the improving effects on the adhesion to aggregates and the toughness of modified asphalt can be enhanced. Such (meth)acrylic resin preferably has an acid value of not less than 10 mg KOH/g. When the acid value is less than 10 mg KOH/g, the improving effects on the adhesion to aggregates and the toughness of modified asphalt may possibly be unsatisfactory. The above-mentioned acid value is preferably not more than 100 mg KOH/g. When it exceeds 100 mg KOH/g, a decreased solubility in asphalt may result. An acid value of 10 to 90 mg KOH/g is more preferred, and 15 to 80 mg KOH/g is still more preferred.

Suited for use as monomers capable of forming polymers constituting the above-mentioned (meth)acrylic resin are (meth)acrylic acid;(meth)acrylates containing 1 to 30 atoms such as alkyl (meth)acrylates of which alkyl ester moiety is methyl, ethyl, propyl, butyl, octyl, 2-ethylhexyl, cyclohexyl, lauryl, stearyl, behenyl or the like, hydroxyethyl (meth)acrylate, hydroxypropyl (meth)acrylate, glycidyl (meth)acrylate, methoxyethyl (meth)acrylate, ethoxyethyl (meth)acrylate, ethoxyethoxyethyl (meth)acrylate, cyclohexyl (meth)acrylate and stearyl (meth)acrylate; di(meth)acrylates such as tetraethylene di (meth)acrylate; styrenic monomers such as α-methylstyrene, vinyltoluene and styrene; vinyl ether monomers such as methyl vinyl ether, ethyl vinyl ether and isobutyl vinyl ether; unsaturated carboxylic acids and esters thereof, such as fumaric acid, monoalkyl fumarates, dialkyl fumarates, maleic acid, monoalkyl maleates, dialkyl maleates, itaconic acid, monoalkyl itaconates and dialkyl itaconates; (meth)acrylonitrile, butadiene, isoprene, vinyl chloride, vinylidene chloride, vinyl acetate, vinyl ketones, vinylpyridine, vinylpyrrolidone, vinylcarbazole and (meth)acrylamides.

(Meth)acrylic resin-constituting polymers can be obtained by polymerizing a monomer composition comprising one or more of the monomers mentioned above. For obtaining asphalt modifiers readily compatible with asphalt, however, it is preferred that the (meth)acrylic monomer content be not less than 90% by weight per 100% by weight of the monomer composition and that the content of a (meth)acrylic monomer(s) having an ester moiety containing not less than 6 carbon atoms, among others, be not less than 10% by weight, more preferably not less than 20% by weight, still more preferably not less than 30% by weight, in particular not less than 40% by weight, most preferably not less than 50%by weight. Particularly preferred among others are polymers produced from (meth)acrylic acid, cyclohexyl methacrylate and stearyl acrylate as main constituents, namely (meth)acrylic resins comprising polymers obtained by using these monomers in an amount of not less than 50% by weight per 100% by weight of the monomer composition, since such polymers are readily soluble in asphalt.

The above-mentioned (meth)acrylic resin preferably has a weight average molecular weight of 5,000 to 200,000. When the molecular weight is less than 5,000, the toughness-improving effect may be insufficient. When it exceeds 200,000, the resin may be hardly soluble in asphalt. More preferably, it is 5,000 to 150,000 and, still more preferably, it is 10,000 to 100,000.

The steric structure of the above-mentioned (meth)acrylic resin may be linear, branched, star-shaped, or grafted. Star-shaped polymers having a star-shaped structure are preferred among others since they can improve the physical properties of asphalt while maintaining good workability without unnecessarily increasing the viscosity of modified asphalt.

A judicious method of producing the above-mentioned star-shaped polymers comprises carrying out radical polymerization of a monomer composition in the presence of a polyfunctional mercaptan having three or more mercapto groups, with the mercapto groups serving as initiation sites.

The above-mentioned polyfunctional mercaptan is preferably one derived from at least one compound selected from the group consisting of the tri- to hexafunctional mercaptans such as trimethylolpropane trithioglycolate, trimethylolpropane trithiopropionate, pentaerythritol tetrakisthioglycolate, pentaerythritol tetrakisthiopropionate, dipentaerythritol hexakisthioglycolate and dipentaerythritol hexakisthiopropionate.

The above-mentioned radical polymerization can be carried out in the manner of ordinary radical polymerization, for example bulk polymerization, solution polymerization, suspension polymerization or emulsion polymerization. In this case, the polymerization temperature is preferably within the range of 30 to 200° C., more preferably 60 to 150° C. Usable as the radical polymerization initiator in the radical polymerization are those in general use, for example azo type polymerization initiators such as 2,2′-azobisisobutyronitrile, 2,2′-azobis(2-methylbutyronitrile) and 2,2′-azobiscyclohexanecarbonitrile; and peroxide polymerization initiators such as benzoyl peroxide.

As for the ratios of the elastomer and (meth)acrylic resin in the above-mentioned asphalt modifier, the ratio of the (meth)acrylic resin is 0.01 to 1.5 parts by weight relative to 1.0 part by weight of the elastomer. When the (meth)acrylic acid is used in a larger amount such that the above-mentioned ratio exceeds 1.5, the resulting modified asphalt becomes too rigid and the impact resistance and tenacity thereof are rather deteriorated. When the above-mentioned ratio is smaller than 0.01, the (meth)acrylic resin content is insufficient, so that the resulting modified asphalt becomes low in toughness and poor in adhesion to aggregates. The above-mentioned ratio is preferably 0.05 to 0.5 since the impact resistance of the resulting modified asphalt then becomes further improved. More preferably, the above-mentioned ratio is 0.1 to 0.5 since modified asphalt further improved in adhesion to aggregates can then be obtained.

The ratio of the total amount of the essential constituents, namely the elastomer and (meth)acrylic resin, on the solid basis, in the above-mentioned asphalt modifier, is 30% to 100% by weight. When the total amount of the essential constituents elastomer and (meth)acrylic resin is less than 30% by weight, some of the physical properties required of modified asphalt may become short of the required levels in certain cases. For example, when the content of a petroleum resin is high and accordingly the total content of the above-mentioned essential constituents becomes less than 30% by weight, the modified asphalt becomes too rigid and the tenacity thereof decreases, hence the durability thereof decreases with respect to aggregate scattering. When the content of a process oil is excessive and accordingly the content of the above-mentioned essential constituents becomes less than 30% by weight, the modified asphalt becomes too soft and the aggregate holding power and flow resistance thereof become insufficient. Considering that the weight ratio between the elastomer and (meth)acrylic resin is 1/0.01 to 1.5, as mentioned above, and that the total amount thereof accounts for 30% to 100% by weight, the preferred content of the elastomer in the asphalt modifier is within the range of 12 to 99% by weight and the preferred content of the (meth)acrylic resin is within the range of 0.3 to 60% by weight. The content of other constituents than the essential constituents, for example a petroleum resin and/or a process oil, is 0 to 70% by weight.

The above-mentioned asphalt modifier may contain one or more constituents other than the essential constituents elastomer and (meth)acrylic resin unless the effects of the invention are unfavorably affected thereby. Suitable as such constituents other than the essential constituents are process oils and petroleum resins.

The above-mentioned asphalt modifier is preferably used in the form of solutions such as aqueous solutions or toluene solutions; in the form of solids such as flakes, pellets and powders; or in emulsified forms such as emulsions and latexes. Among them, solid forms are preferred since they can be added to and mixed with asphalt with ease. The elastomer and (meth)acrylic resin may be added separately, or these may be mixed up each in the form of a solution in advance and, after drying, may be added, as a solid mixture, to asphalt. Thus, the mode of use or the manner of addition of the asphalt modifier is not particularly restricted unless the effects of the present invention are unfavorably affected thereby.

The above-mentioned asphalt modifier, which comprises the elastomer and (meth)acrylic resin as essential constituents, as mentioned above, exhibits the effects of the present invention. The reason may be explained as follows. First, the elastomer is effective for improving the toughness and tenacity of asphalt. Further, owing to the resemblance of the stearyl, cyclohexyl or like group to naphthenes, which are asphalt components, the (meth)acrylic resin is well compatible with asphalt and then exhibits its effects for improving the toughness and adhesion to aggregates (resistance to stripping) of asphalt. Since these effects are exhibited synergistically, it becomes possible to improve both the adhesion to aggregates and toughness of asphalt without using the above-mentioned constituents in large amounts. Thus, improvements can be achieved by preventing the phase separation of asphalt from the modifier as resulting from the use of the elastomer in larger amounts from occurring, the workability from being impaired and the production cost from rising. Accordingly, the above-mentioned modifier can appropriately be used in modified asphalt and modified asphalt mixtures for forming various pavements, in particularly draining pavements, which are required to have high levels of durability.

The present invention also provides a modified asphalt species comprising asphalt, an elastomer and a (meth)acrylic resin as essential constituents in which the weight ratio of the asphalt, elastomer and (meth)acrylic resin are such that the elastomer accounts for 1 to 10 parts by weight and the (meth)acrylic resin for 0.01 to 15 parts by weight per 100 parts by weight of asphalt. Such modified asphalt species also exhibits the effects of the present invention.

Suitable as the above-mentioned asphalt are natural asphalt species such as lake asphalt and gilsonite; and petroleum asphalt species such as straight asphalt, semi-blown asphalt and blown asphalt. The above-mentioned elastomer and (meth)acrylic resin are the same as those used in the asphalt modifier mentioned above.

When the weight ratio of the above-mentioned elastomer is below than the range given above, the asphalt toughness-improving effect is insufficient and, when it exceeds the above-mentioned range, the viscosity of the modified asphalt becomes high, rendering the workability unsatisfactory. The elastomer content is preferably 2 to 9 parts by weight, more preferably 3 to 8 parts by weight, per 100 parts by weight of asphalt.

When the weight ratio of the above-mentioned (meth)acrylic resin is below the range given above, the toughness of the modified asphalt becomes weak and, when it exceeds the above-mentioned range, the asphalt becomes too rigid and lacking in flexibility, possibly causing cracking and so on. The ratio is preferably 0.05 to 5 parts by weight, more preferably 0.1 to 5 parts by weight, per 100 parts by weight of asphalt.

The above-mentioned modified asphalt is composition comprising asphalt and the elastomer and (meth)acrylic resin incorporated therein in the weight ratios mentioned above. It may occur as a solid, an aqueous dispersion, which is the so-called asphalt emulsion, or a foamed body, which is the so-called foamed asphalt. It may contain one or more constituents other than the above-mentioned essential constituents unless the effects of the invention are unfavorably affected thereby. Suitable for use as such constituents other than the essential constituents are process oils and petroleum resins.

The modified asphalt mentioned above can be produced by admixing, with asphalt, an asphalt modifier prepared by compounding the elastomer and (meth)acrylic resin as essential constituents, or by admixing, with asphalt, the elastomer and (meth)acrylic resin separately. Preferred among these methods is the production method comprising admixing, with asphalt, an asphalt modifier prepared by compounding the elastomer and (meth)acrylic resin as essential constituents.

The adhesion to aggregates, toughness/tenacity, and viscosity at 60° C., among others, can be used as the indexes of modifications in the above-mentioned characteristics of modified asphalt. The adhesion to aggregates can be evaluated by carrying out a stripping resistance test according to the Japan Petroleum Institute standard JPI-5S-27 “Method of Testing Asphalt Coats for Stripping Level”, for instance. The toughness/tenacity can be evaluated by a measurement method according to the toughness/tenacity testing method (in conformity with JEAAS) described in the “Manual of Pavement Testing Methods” edited by the Japan Road Association (published November, 1988), pages 456-461, for instance, and the viscosity at 60° C. can be evaluated by measuring the viscosity of modified asphalt in accordance with the Japan Asphalt Association standard JAA-001 “Testing Method for Absolute Viscosity of Asphalt”, for instance.

The desirable numerical value of each of these indexes of modification varies according to the target pavement. For use in draining pavements, in particular, preferred values can be selected in carrying out the invention within the ranges described below under (1) to (4), and modified asphalt showing the thus-selected values can appropriately be used in draining pavements to provide them with good durability. Such modified asphalt of the present invention for which the indexes of modification have been selected within the respective preferred numerical value ranges belong to a preferred mode of embodiment of the present invention.

(1) The adhesion to aggregates is preferably not more than 9% as expressed in terms of percent stripped surface area, more preferably not more than 7%, still more preferably not more than 5%. When this exceeds 9%, aggregates tend to be scattered with ease.

(2) The toughness is preferably 15 to 40 N.m, more preferably 20 to 30 N.m. When it is less than 15 N.m, the asphalt will be too soft and the durability will be insufficient. When it exceeds 40 N.m, the asphalt will become too rigid, possibly leading to cracking.

(3) The tenacity is preferably not less than 10 N.m, more preferably not less than 15 N.m. When it is less than 10 N.m, the impact resistance may possibly be insufficient.

(4) The viscosity at 60° C. is preferably 200 to 100,000 Pa.s, more preferably 5,000 to 50,000 Pa.s. When it is less than 200 Pa.s, the flow resistance is insufficient and, when it exceeds 100,000 Pa.s, the workability becomes impaired.

The present invention also provides a modified asphalt mixture which comprises, as essential constituents, the above-mentioned modified asphalt and an aggregate. Such modified asphalt mixture is good in workability and can form asphalt pavements having good durability.

Suitable as the above-mentioned aggregate are crushed stone, steel slag, and sand. These may be used singly or in combination.

In the above-mentioned asphalt mixture, the mixing ratio between the modified asphalt and aggregate is preferably such that the weight ratio modified asphalt/aggregate is within the range of 1/99 to 30/70. When the mixing ratio of aggregate relative to modified asphalt is higher as compared with 1/99, the workability of the asphalt mixture may become impaired and, when the mixing ratio of aggregate relative to modified asphalt is lower as compared with 30/70, the durability of asphalt pavements formed from the asphalt mixture may become poor. A more preferred range is 3/97 to 10/90. This brings about a sufficient level of durability and also an economic improvement.

The above-mentioned asphalt mixture may contain one or more constituents other than the essential constituents mentioned above unless the effects of the invention are sacrificed. Suitable for use as such constituents other than the essential constituents are fillers and additives, such as stone powder and slaked lime.

As for the method of producing the above-mentioned asphalt mixture, use may be made of the method comprising admixing the modified asphalt with an aggregate, together with another or other additives to be used according to need (premix method), or the method comprising admixing the asphalt modifier, asphalt and an aggregate, together with another or other additives to be used according to need (plant mix method).

In producing the above-mentioned asphalt mixture, the mixing up of the asphalt modifier, asphalt and an aggregate or the mixing of the modified asphalt with an aggregate can be carried out, for example, at 150 to 220° C. when the penetration of the original asphalt is 60 to 80.

The present invention further relates to a pavement method of modified asphalt which uses the above-mentioned asphalt mixture. According to the method of modified asphalt in accordance with the invention, the viscosity of the modified asphalt will not increase unnecessarily, as already mentioned hereinabove, so that the workability is satisfactory and asphalt pavements excellent in durability can be formed. In such pavement method of modified asphalt, the compaction and breakdown rolling compaction of the modified asphalt mixture can be carried out in the same manner as in the case of an asphalt mixture in which unmodified straight asphalt is used.

The asphalt mixture technology of the invention can be applied to dense-graded, fine-graded, open-graded and other various asphalt mixtures and various gap-graded asphalt mixtures, and provides various asphalt mixtures suitable for use in the fields of application where high durability is required, in particular open-graded asphalt mixtures to be applied to draining pavements. Thus, the asphalt mixture of the present invention can be applied not only in ordinary pavements but also in permeable pavements, draining pavements and semiflexible pavements. The pavement method of the modified asphalt which is carried out using such asphalt mixture as mentioned above can be applied to various kinds of pavements.

The present invention further provides a composition which comprises a styrenic elastomer and a (meth)acrylic resin produced by polymerizing a monomer composition comprising, as essential constituents, a (meth)acrylate of which ester moiety has a cyclohexyl group and a (meth)acrylate of which ester moiety has an alkyl group containing not less than 8 carbon atoms. Such composition can appropriately be used as a compatible polymer mixture in the whole range of use of styrenic elastomers. In the practice of the invention, the (meth)acrylic resin and styrenic elastomer each may comprise one single species or a combination of two or more species.

The styrenic elastomer to be used in the practice of the invention maybe any polymer produced by polymerizing a monomer composition comprising styrene and a diene monomer as essential constituents, or a hydrogenation product derived therefrom. It may comprise one single species or two or more species. Suitable examples are styrene-butadiene-styrene triblock copolymers (SBSs), styrene-butadiene diblock copolymers (SBs) styrene-isoprene-styrene (SIS) block copolymers and styrene-ethylene-butene-styrene block copolymers (SEBSs). Among them, SBSs are preferred in the practice of the invention and can fully exhibit the effects of the invention.

The (meth)acrylic resin to be used in accordance with the invention is a resin produced by polymerizing a monomer composition comprising, as essential constituents, a (meth)acrylate of which ester moiety has a cyclohexyl group and a (meth)acrylate of which ester moiety has an alkyl group containing not less than 8 carbon atoms. In the practice of the invention, the (meth)acrylic resin may comprise only one of such polymers or two or more of them.

The expression “of which ester moiety has a cyclohexyl group” means that, in the ester moiety represented by —COOR (wherein R represents a hydrocarbon group), R is a cyclohexyl group. The total content of the (meth)acrylate of which ester moiety has a cyclohexyl group and the (meth)acrylate of which ester moiety has an alkyl group containing not less than 8 carbon atoms in the monomer composition, which is taken as 100% by weight, is preferably not less than 50% by weight, more preferably not less than 60%, still more preferably not less than 70%, most preferably not less than 80%. Those (meth)acrylic resins which are constituted of polymers mainly made from (meth)acrylic acid, cyclohexyl methacrylate and stearyl acrylate, namely polymers obtained by polymerization using these monomers in an amount of not less than 50% by weight in 100% by weight of the monomer composition, are preferred since they are most soluble in styrenic elastomers.

As for the monomers capable of forming polymers constituting the above-mentioned (meth)acrylic resin, the same ones as those mentioned above are suitable, and the (meth)acrylic monomer content is preferably not less than 90% by weight relative to 100% by weight of the monomer composition so that the resin may be readily compatible with the styrenic elastomer. The preferred steric structure and method of production of the (meth)acrylic resin are as mentioned hereinabove.

The (meth)acrylic resin to be used in the practice of the present invention is preferably one such that a 50-μm-thick coat formed from a composition prepared by adding 1 to 50 parts by weight of the (meth)acrylic resin to 100 parts by weight of styrenic elastomer shows a haze of 1 to 50%. Those (meth)acrylic resin which satisfies such requirement are well compatible with styrenic elastomers and, therefore, can appropriately be used as compatibilizers for styrenic elastomers and can suitably be applied in whole range of use of improved polystyrenic elastomers, so that the styrenic elastomers can exhibit their effects to the full in various uses and can be provided with good characteristics of the (meth)acrylic resins. In a preferred embodiment of the invention, the 50-μm-thick coat mentioned above has a haze of not more than 30%, more preferably not more than 15%.

In the measurement of the above-mentioned property of (meth)acrylic resins, the coat-forming composition does not contain any of pigments or other constituents. The styrenic elastomer is one to be contained in the composition together with the (meth)acrylic resin. As for the method of forming coats from the composition, the following method is suitable.

(Coat Formation Method)

A 10% (by weight) solution of the styrenic elastomer/(meth)acrylic resin composition in cyclohexane is prepared by adding 100 parts by weight of the styrenic elastomer and 1 to 50 parts by weight of the (meth)acrylic resin to cyclohexane. This solution is coated over a transparent PET film and dried to give a 50-μm-thick coat.

The level of addition of the (meth)acrylic resin to 100 parts by weight of the styrenic elastomer is preferably not less than 2 parts by weight but not more than 40 parts by weight, more preferably not less than 5 parts by weight but not more than 30 parts by weight, still more preferably not less than 7 parts by weight but not more than 20 parts by weight.

The haze H of the above-mentioned coat is expressed by the ratio, multiplied by 100, of diffuse transmittance Td to total luminous transmittance (Tt) as determined by exposing the coat to light. It can be calculated as follows:

H=(Td/Tt)×100.

Such coat haze measurement can be performed according to JIS K 7105 “Testing Methods of Optical Properties of Plastics”, for example, using a Nippon Denshoku Kogyo model “ND-1001DP” (trademark) apparatus.

(Measurement Conditions)

The measurement is carried out in a constant-temperature, constant-humidity room at 23° C. and 65% RH. For reasons of convenience in coat preparation, test specimens are prepared from a coat produced on a transparent PET film. Each test specimen is 50 mm square and the coat has thickness of 50 μm.

In the practice of the present invention, the (meth)acrylic resin preferably has a weight average molecular weight of not less than 1,000 but not more than 100,000. The effects of the present invention can then be exhibited to the full. More preferably, the molecular weight is not less than 5,000 but not more than 70,000.

In a preferred embodiment of the composition of the present invention, the haze of a 50-μm-thick coat formed from the composition is not less than 1% but not more than 50%. Those compositions, namely styrenic elastomer/(meth)acrylic resin compositions, which satisfy such condition are excellent in compatibility between the styrenic elastomers and (meth)acrylic resins and in transparency and can exhibit the effects of the present invention to the full. More preferably, the haze of the 50-μm-thick coat formed from the composition is not more than 30%, still more preferably not more than 15%. The above-mentioned method is suitable as the method of forming coats.

In the composition of the present invention, the mixing ratio between the styrenic elastomer and (meth)acrylic resin can be selected according to the intended use of the composition, the species of the styrenic elastomer and (meth)acrylic resin and other factors. Preferably, however, the styrenic elastomer-to-(meth)acrylic resin weight ratio (styrenic elastomer/(meth)acrylic resin) is not less than 100/1 but not more than 100/50. When the ratio is less than 100/1, the effects of the (meth)acrylic resin may be insufficient and, when it is more than 100/50, the original characteristics of the styrenic elastomer may be impaired. More preferably, the ratio is not less than 100/5 and not more than 100/30.

The composition technology of the invention can suitably be applied to the whole area of uses of styrenic elastomer modification, in particular to the cases where styrenic elastomers are used for modifying asphalt, for modifying such resins as polyolefins or polystyrene, or for preparing adhesives or pressure-sensitive adhesives. In particular, it can suitably be used in modifying asphalt using a styrene-butadiene-styrene triblock copolymer (SBS) or styrene-butadiene diblock copolymer (SB). More preferably, it can be used in modifying asphalt with an SBS and, on that occasion, modified asphalt having good heat stability can be produced even when straight asphalt, in which SBSs are said to be hardly soluble, is used as the asphalt. The use of the composition of the invention in asphalt modification is one of the preferred embodiments of the present invention.

The composition of the invention is suitably used in the form of solutions such as aqueous solutions or toluene solutions; solids such as flakes, pellets or powders; or emulsified forms such as emulsions or latexes. Among them, solid forms are preferred which can easily be admixed and blended with asphalt, resins and so on. The styrenic elastomer and (meth)acrylic resin may be separately added to asphalt, resins or the like, or they may be mixed together in advance each in a solution form and, after drying, may be added in a solid mixture form. The manner of use or the method of addition of the composition of the present invention is thus not particularly restricted unless the effects of the invention are unfavorably affected thereby.

The composition of the invention may contain one or more other constituents than the essential ones, namely the styrenic elastomer and (meth)acrylic resin, unless the effects of the invention are unfavorably affected thereby. For example, when the composition is to be used as an asphalt modifier, a process oil and/or a petroleum resin is preferably used.

The modified asphalt comprising the above-mentioned composition and asphalt as essential constituents can fully exhibit the effects of modification by the styrenic elastomer owing to its containing the above-mentioned (meth)acrylic resin, and show good heat stability. Such modified asphalt is one of the preferred embodiments of the present invention.

The above-mentioned asphalt includes, as species suited for use, those mentioned hereinabove, and may comprise one or more of them. The (meth)acrylic resin in the composition of the invention can improve the heat stability of modified asphalt to a satisfactory extent even when straight asphalt, in which SBSs are said to be most hardly soluble, is used. Therefore, the composition is judiciously applied to the cases where asphalt comprising, as essential constituent, straight asphalt having a CI index of not less than 0.3 is used. Thus, modified asphalt comprising, as essential constituent, straight asphalt having a CI index of not less than 0.3 is one of the preferred embodiments of the present invention.

The term “CI index” as used herein is short for “Colloidal Instability Index”. While asphalt is a mixture composed of various components, the components in asphalt can be divided into four classes, namely saturated components, aromatics, resins and asphaltenes, by the technique prescribed by the Japan Petroleum Institute, and the index can be determined as follows:

CI index=(asphaltenes+saturated components)/(resins+aromatics)

The styrenic elastomer is readily soluble in resins and aromatics but hardly soluble in asphaltenes and saturated components. Therefore, the styrenic elastomer, such as an SBS, is generally more soluble in asphalt having a lower CI index. In the prior art field of modified asphalt, asphalt species having a CI index of less than 0.3 are used for obtaining modified asphalt having good heat stability.

As for the mixing ratio of the composition of the invention in the above-mentioned modified asphalt, it is preferred that the (meth)acrylic resin in the compounds amounts to not less than 0.01 part by weight, but not more than 15 parts by weight, per 100 parts by weight of asphalt. When the ratio is less than 0.01 part by weight, the compatible effect on SBS and asphalt may be insufficient and, when it is more than 15 parts by weight, the characteristics intrinsic in asphalt may be impaired. Preferably, the (meth)acrylic resin amounts to not less than 5 parts by weight, and more preferably not less than 0.1 part by weight, per 100 parts by weight of asphalt.

The above-mentioned modified asphalt contains one or more styrenic elastomers together with the (meth)acrylic resin and asphalt. Preferred embodiment is what contains an SBS.

As for the molecular weight of the SBS, it is preferably having a weight average molecular weight of not less than 50, 000 but not more than 500,000. When the molecular weight is less than 50,000, the cohesive force is so weak that the strength of asphalt may not be improved to a sufficient level. When it is more than 500,000, the SBS may become hardly soluble in asphalt. More preferably, it is not less than 100,000, still more preferably not less than 150,000, but not more than 400,000.

As for the mixing ratio of the styrenic elastomer in the above-mentioned modified asphalt, the ratio in the case of an SBS, for instance, is preferably not less than 1 part by weight, but not more than 20 parts by weight, per 100 parts by weight of asphalt. When the ratio is less than 1 part by weight, the toughness increasing effect on asphalt becomes insufficient and when it is more than 20 parts by weight, the viscosity of modified asphalt increases and the workability becomes unsatisfactory. Preferably, the addition level is not less than 2 parts by weight, but not more than 15 part by weight, more preferably not less than 3 parts by weight, but nor more than 10 parts by weight, per 100 parts by weight of asphalt.

The above-mentioned modified asphalt is a composition comprising the (meth)acrylic resin and styrenic elastomer incorporated in asphalt in the respective weight ratios mentioned above. It may take the form of a solid, or an aqueous dispersion such as the so-called asphalt emulsion, or a foamed body such as the so-called foamed asphalt. It may contain one or more constituents other than the above-mentioned essential ones unless the effects of the present invention are unfavorably affected thereby. Suitable as such constituent other than the essential ones are process oils and petroleum resins.

The method of producing the above-mentioned modified asphalt may comprise mixing asphalt with the asphalt modifier comprising the (meth)acrylic resin and styrenic elastomer as essential constituents, or mixing asphalt with the (meth)acrylic resin and styrenic elastomer separately and individually. It is preferred, among others, that the modified asphalt be produced by mixing asphalt with the asphalt modifying material comprising the (meth)acrylic resin and styrenic elastomer as essential constituents.

As for an index of modification of the above-mentioned modified asphalt, the change in softening point of modified asphalt can be used as the index of heat stability. The softening point can be evaluated by the method mentioned below.

<The Measuring Method of Softening Point>

The measurement is carried out by the ring and ball method according to JIS K 2207 “Petroleum asphalts”.

The specimen has an upper diameter of 19 mm and a lower diameter of 16 mm and a thickness of 6.4 mm. The ball weight is 3.5 g, and the temperature is raised from ordinary temperature at a rate of 5° C./min.

If the modified asphalt has poor heat stability, the SBS undergoes phase separation to form an upper layer, so that the softening point of the upper layer rises and the softening point of the lower layer falls. In the case of good heat stability, the difference in softening point between the upper layer and lower layer is not more than 5° C.

### BEST MODES FOR CARRYING OUT THE INVENTION

The following examples illustrate the present invention in further detail. These examples are, however, by no means limitative of the scope of the present invention.

### EXAMPLE 1

Production of Acrylic Resin (1)

[Preparation of Initiator Solution (1)]

Pentaerythritol tetrakisthioglycolate (7.2 weight parts), 1.44 weight parts of 2,2′-azobis(2-methylbutyronitrile) and 30.0 weight parts of ethyl acetate were mixed up and the mixture was poured into a dropping funnel for use as initiator solution (1).

[Polymerization]

A 2-liter flask was charged with 3.6 weight parts of tetraethylene glycol diacrylate, 237.6 weight parts of cyclohexyl methacrylate, 108.0 weight parts of stearyl acrylate, 10.8 weight parts of acrylic acid and 330.0 weight parts of ethyl acetate, and the contents were heated on a water bath at 90° C. with stirring in a nitrogen atmosphere. When the inside temperature became almost constant, one third of the initiator solution (1) was added dropwise to thereby start the polymerization. At 50 minutes and 90 minutes after the start of the polymerization, two one-third portions of the initiator solution (1) were respectively added dropwise for further progress of the polymerization. At 240 minutes after the start of the polymerization, the reaction mixture was cooled and the polymerization was finished thereby. Thus was obtained a solution of an acrylic resin (1) with a weight average molecular weight of 39,000.

[Drying]

The acrylic resin (1) solution obtained was completely dried at 180° C. in a vacuum drier, followed by cooling and further by crushing, to give the acrylic resin (1) in a form of flake.

[Tensile Test]

The acrylic resin (1) was subjected to tensile test according to JIS K 7113. The elongation at 23° C. was 320%.

Production of Modified Asphalt (1)

A 500-mL metal-made kettle was charged with 200 weight parts of straight asphalt with a penetration of 60 to 80. While heating with stirring on an oil bath at 180° C. in a nitrogen atmosphere, 5 weight parts of a styrene-butadiene-styrene block copolymer (SBS) “TUFPRENE® 315” (styrene content 20%, weight average molecular weight 11,100, elongation at 23° C. 880%) produced by Asahi Chemical Industry was added, the mixture was stirred for 1 hour, 5 weight parts of the acrylic resin (1) was then added, and the whole mixture was further stirred for 1 hour to give modified asphalt (1).

The ratios of the respective modifiers relative to straight asphalt are shown in Table 1.

Physical Property Evaluation of Modified Asphalt

The modified asphalt (1) obtained was measured for stripped surface area percentage, viscosity at 60° C. and toughness/tenacity, as mentioned below. The results are shown in Table 2.

[Stripped Surface Area Measurement]

For evaluating the modified asphalt for adhesion to aggregates, the stripped area surface was measured according to the Japan Petroleum Institute standard JPI-5S-27 Method of Testing Asphalt Coats for Stripping Level. While it is indicated in this testing method that the stripped surface area percentage is to be determined by visual observation, a photograph of the aggregate after testing was registered in a computer, the area of the whole aggregate and the area of the stripped portion were determined using image processing software and the percentage was calculated therefrom to thereby improve the precision of the evaluation.

[Viscosity at 60° C.]

The viscosity at 60° C., which serves as an index of flow resistance and workability of modified asphalt, was measured according to the Japan Asphalt Association standard JAA-001 “Testing Method for Absolute Viscosity of Asphalt”.

[Toughness/Tenacity Measurement]

The toughness, which is indicative of the aggregate holding power of modified asphalt, and the tenacity, which is indicative of the caking power of modified asphalt, was measured according to the “toughness/tenacity testing method” described in the “Manual of Pavement Testing Methods” edited by the Japan Road Association (published November, 1988).

### EXAMPLES 2 AND 3 AND COMPARATIVE EXAMPLES 1 TO 5

Modified asphalt species (Example 2: modified asphalt (2), Example 3: modified asphalt (3)) were prepared in the same manner as in Example 1 by adding TUFPRENE® 315, the acrylic resin (1) and a petroleum resin “NEO POLYMER® 150” produced by Nippon Petrochemicals according to the formulations shown in Table 1. NEO POLYMER® 150 was added simultaneously with TUFPRENE® 315. The modified asphalt was evaluated in the same manner as in Example 1. The results are shown in Table 2.

### COMPARATIVE EXAMPLE 6

Straight asphalt with a penetration of 60 to 80 was evaluated in the same manner as in Example 1. The results are shown in Table 2.

### EXAMPLE 4

Production of Acrylic Resin (2)

[Preparation of Initiator Solution (2)]

Pentaerythritol tetrakisthioglycolate (6.0 weight parts), 1.2 weight parts of 2,2′-azobis(2-methylbutyronitrile) and 30.0 weight parts of ethyl acetate were mixed up and the mixture was poured into a dropping funnel for use as initiator solution (2).

[Polymerization]

A 2-liter flask was charged with 180 weight parts of cyclohexyl methacrylate, 105 weight parts of stearyl acrylate, 15 weight parts of acrylic acid and 270 weight parts of ethyl acetate, and the contents were heated on a water bath at 90° C. with stirring in a nitrogen atmosphere. When the inside temperature became almost constant, one third of the initiator solution (2) was added dropwise to thereby start the polymerization. At 40 minutes and 90 minutes after the start of the polymerization, two one-third portions of the initiator solution (2) were respectively added dropwise for further progress of the polymerization. At 240 minutes after the start of the polymerization, the reaction mixture was cooled and the polymerization was finished thereby. Thus was obtained a solution of an acrylic resin (2) with a weight average molecular weight of 30,000.

[Tensile Test]

The solution of acrylic resin (2) was dried under reduced pressure in the same manner as in Example 1, followed by tensile test. The elongation at 23° C. of the acrylic resin (2) was 380%.

Production of Modifier A

The SBS “KRATON® D-1101” (18 weight parts; styrene content 31%, weight average molecular weight 159,000, elongation at 23° C. 880%) produced by Kraton Polymer Japan was dissolved in 150 weight parts of toluene, and 6 weight parts of the solution of acrylic resin (2) (namely 3 weight parts as acrylic resin solid matter) was added thereto, followed by stirring until a homogeneous solution was obtained. This mixed solution of KRATON® D-1101/acrylic resin (2) was completely dried in a vacuum drier at 150° C. and, after cooling, the dried matter was cut to pellets to give modifier A.

Production of Modified Asphalt (4)

A 500-mL metal-made kettle was charged with 200 weight parts of straight asphalt with a penetration of 60 to 80 and 12 weight parts of the aromatic process oil “Komorex 700” produced by Nippon Mitsubishi Oil Corporation. While heating with stirring the charge on an oil bath at 200° C. in a nitrogen atmosphere, 14 weight parts of the modifier A was added, followed by 3 hours of stirring to give modified asphalt (4).

Physical Property Evaluation of Modified Asphalt (4)

The thus-obtained modified asphalt (4) was evaluated in the same manner as in Example 1. The results are shown in Table 2.

Modified Asphalt Mixture Production

For obtaining an open-graded modified asphalt mixture usable in draining pavements, 830 weight parts of No. 6 crushed stone, 120 weight parts of crushed sand, 5 weight parts of stone powder and 50 weight parts of the modified asphalt (4) were each separately heated in an oven at 180° C. for 1 hour and all of them were then charged into a metal-made vessel and thoroughly mixed up. An open-graded modified asphalt mixture was thus obtained. The temperature of the modified asphalt mixture during mixing was 170° C.

Physical Property Evaluation of Modified Asphalt Mixture

The evaluation was performed by the test methods mentioned below so that the durability as a draining pavement might be confirmed by indoor testing.

[Cantabro Test]

For evaluating the durability against aggregate scattering, the above-mentioned open-graded modified asphalt mixture was tested by the “cantabro test method” described in the “Manual of Pavement Testing Methods” cited hereinabove. The compaction temperature in preparing test specimens was 156° C., the average degree of compaction was 101.0%, and the average void content was 19.9%. As a result of testing at 20° C., the average cantabro loss was 11.2%.

[Wheel Tracking Test]

For evaluating the flow resistance, the open-graded modified asphalt mixture mentioned above was tested by the “Method for Wheel Tracking Test” described in the “Manual of pavement testing methods” cited hereinabove. The compaction temperature in preparing test specimens was 156° C., and the average degree of compaction was 101.5%. As a result of testing at 60° C., the mean dynamic stability value was 6576 times/mm.

Pavement With Modified Asphalt Mixture

A 5 m×30 m area of a road was paved with the above-mentioned modified asphalt mixture by laying, leveling and roller compacting the same in a known manner. No problem was encountered in laying, leveling and compacting. Observation after a month revealed almost no surface layer aggregate scattering. No rut was revealed, either.

### EXAMPLE 5

Production of Acrylic Resin (3)

[Preparation of Initiator Solution (3)]

2,2′-Azobis(2-methylbutyronitrile) (12 weight parts) and 30 weight parts of ethyl acetate were mixed up and the mixture was charged into a dropping funnel.

[Polymerization]

A 2-liter flask was charged with 201 weight parts of cyclohexyl methacrylate, 90 weight parts of stearyl acrylate, 9 weight parts of acrylic acid and 570 weight parts of ethyl acetate, and the contents were heated on a water bath at 90° C. with stirring in a nitrogen atmosphere. When the inside temperature became almost constant, one third of the initiator solution (3) was added dropwise to thereby start the polymerization. At 60 minutes and 120 minutes after the start of the polymerization, two one-third portions of the initiator solution (3) were respectively added dropwise for further progress of the polymerization. At 240 minutes after the start of the polymerization, the reaction mixture was cooled and the polymerization was finished thereby. Thus was obtained a solution of an acrylic resin (3) with a weight average molecular weight of 38,000.

[Drying]

The acrylic resin (3) solution was dried, cooled and crushed in the same manner as in Example 1 to give the acrylic resin (3) in a form of flake.

[Tensile Test]

The acrylic resin (3) was subjected to tensile test the same manner as in Example 1. The elongation at 23° C. was 350%. Production of modified asphalt (5) According to the procedure of Example 4, a 500-mL metal-made kettle was charged with 200 weight parts of straight asphalt with a penetration of 60 to 80, 4 weight parts of “NEO POLYMER® 150” and 16 weight parts of “Komorex 700”. While heating with stirring on an oil bath at 200° C. in a nitrogen atmosphere, 10 weight parts of “KRATON® D-1101” was added, the mixture was stirred for 1 hour, 2 weight parts of the acrylic resin (3) was then added, and the whole mixture was further stirred for 1 hour to give modified asphalt (5).

Physical Property Evaluation of Modified Asphalt (5)

The modified asphalt (5) obtained was evaluated in the same manner as in Example 1. The results are shown in Table 2.

TABLE 1

| | | | Examples | | | | | Comparative Examples | | | | | |
|---|---|---|---|---|---|---|---|---|---|---|---|---|---|
| | | | 1 | 2 | 3 | 4 | 5 | 1 | 2 | 3 | 4 | 5 | 6 |
| Mixing ratio | Elastomer | TUFPRENE ® 315 | 2.5 | 5.0 | 4.0 | — | — | 5.0 | 10.0 | 4.0 | 4.0 | 4.0 | — |
| (weight parts) | | KRATON ® D-1101 | — | — | — | 6.0 | 5.0 | — | — | — | — | — | — |
| of each | Acrylic | (1) | 2.5 | 5.0 | 2.0 | — | — | — | — | — | — | 8.0 | — |
| modifier to | resin | (2) | — | — | — | 1.0 | — | — | — | — | — | — | — |
| straight | | (3) | — | — | — | — | 1.0 | — | — | — | — | — | — |
| asphalt | Petroleum | NEO POLYMER ® 150 | — | — | 3.0 | — | 2.0 | — | — | — | 3.0 | — | — |
| (100 weight | resin | | | | | | | | | | | | |
| parts) | Process | Komorex 700 | — | — | — | 6.0 | 8.0 | — | — | — | — | — | — |
| | Oil | | | | | | | | | | | | |

TABLE 2

| | Examples | | | | | Comparative Examples | | | | | |
|---|---|---|---|---|---|---|---|---|---|---|---|
| | 1 | 2 | 3 | 4 | 5 | 1 | 2 | 3 | 4 | 5 | 6 |
| Stripped area | 3.4 | — | 4.3 | 1.4 | 4.8 | 17.7 | — | 11.0 | 10.1 | — | 46.5 |
| percentage (%) | | | | | | | | | | | |
| Viscosity at | 298 | — | — | 8623 | 7468 | 643 | — | — | — | — | 78 |
| 60° C. | | | | | | | | | | | |
| (Pa · s) | | | | | | | | | | | |
| Toughness (N · m) | — | 18.6 | 20.6 | 20.9 | 20.3 | 15.3 | 10.2 | 14.5 | 21.9 | 13.7 | 4.2 |
| Tenacity (N · m) | — | 10.6 | 15.2 | 16.1 | 15.3 | 9.8 | 7.0 | 8.1 | 14.7 | 6.9 | 0.9 |

As shown in Table 2, the modified asphalt species (1) to (5) obtained in Examples 1 to 5 were all markedly lower in stripped surface area percentage as compared with the straight asphalt of Comparative Example 6, thus showed marked improvements in adhesion to aggregates and, at the same time, showed remarkably higher levels of toughness and tenacity, indicating marked improvements in aggregate holding power and caking power.

From these results, it is evident that although the total amount of modifiers used in the modified asphalt (1) of Example 1 was the same as in Comparative Example 1, the stripped surface area percentage was much smaller with the modified asphalt (1), clearly indicating that the elastomer+acrylic resin combination is superior in adhesion to aggregates to the single use of the corresponding elastomer. Although the total amount of modifiers used in the modified asphalt (2) of Example 2 was the same as in Comparative Example 2, the modified asphalt (2) was much higher in toughness and tenacity, clearly indicating that the elastomer+acrylic resin combination is superior in aggregate holding power and caking power to the single use of the corresponding elastomer.

The modified asphalt of Comparative Example 5, in which the ratio of the acrylic resin (1) was 2.0 weight parts relative to 1.0 weight parts of the elastomer, was rigid, brittle and low in toughness and tenacity due to the higher ratio of the acrylic resin (1). This fact indicates that the use of the (meth)acrylic resin in excess is unfavorable.

The SBS- and petroleum resin-modified asphalt of Comparative Example 3 showed little improvement in stripped surface area percentage as compared with the modified asphalt of Comparative Example 4 as modified with the SBS alone, indicating that the combined use of the petroleum resin alone with the elastomer cannot improve the adhesion to aggregates. On the other hand, with the SBS-, petroleum resin- and acrylic resin-modified asphalt (3) of Example 3, the stripped surface area percentage was very small as compared with the modified asphalts compositions of Comparative Examples 3 and 4, indicating that the combined use of the acrylic resin can markedly improve the adhesion to aggregates.

The elastomer and acrylic resin to be used according to the present invention may be separately added to and mixed with straight asphalt or the like, as in Examples 1 to 3. Further, after preparing the modifier from the elastomer and acrylic resin as single materials, adding it to and mixing with straight asphalt or the like can give the same modification effects as mentioned in Example 4. As for the acrylic resin to be used in accordance with the present invention, it is evident that not only those having a star-shaped structure as used in Examples 1 to 4 but also those having a linear structure like the one used in Example 5 are equally effective in producing the modification effects, namely that the acrylic resin may have any structure. Furthermore, the modified asphalt mixture of Example 4 is very satisfactory in durability against aggregate scattering and in flow resistance, and since a viscosity thereof at 60° C. is not unnecessarily high, it can form a pavement having very good durability without causing any working problem.

### EXAMPLES 6 TO 9

By adding an SBS and one of various acrylic resins in specified ratios (SBS/acrylic resin mixing ratio=9/1), 10% cyclohexane solutions were prepared. The solutions were each coated over a transparent PET film and dried to form a 50-μm-thick coat. This PET+SBS/acrylic resin composition composite coat was measured for haze. The results thus obtained are shown in Table 3.

Haze Measurement Method

The measurement was made according to JIS K 7105 “Testing Methods for Optical Properties of Plastics” using a Nippon Denshoku Kogyo model “ND-1001DP” apparatus.

(Measurement Conditions)

The measurement was carried out in a constant-temperature, constant-humidity room at 23° C. and 65% RH. The size of test specimens was 50 mm square.

### COMPARATIVE EXAMPLE 7

Polymethyl methacrylate was added to an SBS in the same manner as in Example 6, and the PET+SBS/acrylic resin composition composite coat obtained in the same manner was measured for haze. The results are shown in Table 3.

TABLE 3

| | | Example | Example | Example | Example | Comparative |
|---|---|---|---|---|---|---|
| | | 6 | 7 | 8 | 9 | Example 7 |
| Acrylic resin | | 109r | 116a | 215a | 208j | — |
| code number | | | | | | |
| Monomer | CHMA (%) | 60 | 95 | 66 | 50 | 0 |
| composition | STA (%) | 35 | 0 | 0 | 0 | 0 |
| | 2EHA (%) | 0 | 5 | 0 | 50 | 0 |
| | LA (%) | 0 | 0 | 34 | 0 | 0 |
| | AA (%) | 5 | 0 | 0 | 0 | 0 |
| | MMA (%) | 0 | 0 | 0 | 0 | 100 |
| Haze of | D-1101-based haze | 41.4 | 5.1 | 6.6 | 10.5 | 91.5 |
| SBS/acrylic | D-1184-based haze | 26.6 | 2.7 | 4.4 | 4.6 | 90.8 |
| resin | | | | | | |
| composition | | | | | | |

Notes are made to Table 3 in the following. The acrylic resin code numbers are those given to Nippon Shokubai's acrylic resins. CHMA stands for cyclohexyl methacrylate, STA for stearyl acrylate, 2EHA for 2-ethylhexyl methacrylate, LA for lauryl acrylate, AA for acrylic acid, and MMA for methyl methacrylate. As regard to the monomer composition, each numerical value indicates the ratio (weight %) of each monomer in 100% by weight of the monomer composition. The D-1101-based haze means the haze of the composite coat produced by using, as the SBS, the SBS produced by Kraton Polymer Japan and given the code name KRATON D-1101, and the D-1184-based haze is the haze of the composite coat produced by using, as the SBS, the SBS produced by Kraton Polymer Japan and given the code name KRATON D-1184.

### EXAMPLES 10 TO 12

Modified asphalt compositions were prepared by adding one of the SBS/acrylic resin compositions shown in Table 4 to straight asphalt 60 to 80 (product of Kashima Petroleum, CI index 0.39). The modified asphalt compositions were measured for softening point and viscosity at 60° C. Further, the modified asphalt compositions were stored at 180° C. and, after 3 days, the softening points of the upper layer and lower layer of each composition were measured, and the difference therebetween was determined. The results are shown in Table 4.

Conditions of Softening Point Measurement

The measurement was carried out by the ring and ball method according to JIS K 2207 “Petroleum asphalt”.

The specimens had an upper diameter of 19 mm and a lower diameter of 16 mm and a thickness of 6.4 mm. The ball weight was 3.5 g, and the temperature was raised from ordinary temperature at a rate of 5° C./min.

### COMPARATIVE EXAMPLE 8

Modified asphalt was prepared in the same manner as in Examples 10 to 12 using the SBS used in Examples 10 to 12 singly, and the softening point, viscosity at 60° C. and difference in softening point between the values before and after heating were determined. The results are shown in Table 4.

TABLE 4

| | | | | | Com- |
|---|---|---|---|---|---|
| | | Example | Example | Example | parative |
| | | 10 | 11 | 12 | Example 8 |
| Modifier | SBS code number | D-1101 | D-1101 | D-1101 | D-1101 |
| (composition) | (ratio, %) | (85) | (95) | (95) | (100) |
| | Acrylic code number | 109r | 116a | 215a | — |
| | (ratio, %) | (15) | (5) | (5) | — |
| Modifier addition level (phr) | | 5.0 | 5.0 | 5.0 | 5.0 |
| Initial physical | Softening point (° C.) | — | 65.4 | — | 67.9 |
| properties | Viscosity at 60° C. | — | 1770.8 | — | — |
| | (Pa · s) | | | | |
| Physical | Upper layer softening | 68.5 | 64.3 | 65.1 | 79.9 |
| properties | point (° C.) | | | | |
| after | Lower layer softening | 67.0 | 66.0 | 66.0 | 65.3 |
| heating | point (° C.) | | | | |
| | Softening point | 1.5 | 1.7 | 0.9 | 14.6 |
| | difference (° C.) | | | | |

Notes are made to Table 4 in the following. The SBS code number is that of an SBS (product of Kraton Polymer Japan), and the acrylic code numbers are the same as the acrylic resin code numbers defined referring to Table 3. The values in the parentheses referring to the modifier (composition) indicate the ratios (weight %) of the SBS and acrylic resin in 100% by weight of each modifier. The modifier addition level (phr) means the ratio (weight %) of addition of each modifier based on 100% weight of asphalt.

As is evident from Table 3, the coats formed from the (meth)acrylic resin/SBS compositions according to the present invention as shown in Examples 6 to 9 are low in haze, indicating good compatibility. On the other hand, with the polymethyl methacrylate used in Comparative Example 7, the haze was large, indicating no compatibility at all. Further, as is evident from Table 4, in Comparative Example 8 in which the SBS was used singly, the difference between the softening point of upper layer and that of lower layer is large, indicating phase separation of the SBS whereas, when the SBS/(meth)acrylic resin compositions according to the invention were used, as shown in Examples 10 to 12, the difference between the softening point of upper layer and that of lower layer is small, indicating no occurrence of phase separation of the SBS.

### INDUSTRIAL APPLICABILITY

The asphalt modifier according to the invention, which has the constitution mentioned above, can prevent phase separation of asphalt from the modifier, improve the toughness and tenacity without impairing the workability or increasing the production cost, and, further, can provide modified asphalt compositions with increased adhesion to aggregates and improved durability. Thus, it can be applied in any of various asphalt mixtures, such as dense-graded, fine-graded and open-graded ones, as well as in various gap-graded asphalt mixtures, and can be applied not only in ordinary pavements but also in permeable pavements, draining pavements, semiflexible pavements and so on. The composition of the invention, which has the above-mentioned constitution, can be applied to the whole range of uses of styrenic elastomer modification.

1. An asphalt modifier
which comprises an elastomer and a (meth)acrylic resin as essential constituents,
with the ratio of said (meth)acrylic resin being 0.01 to 1.5 parts by weight per 1.0 part by weight of said elastomer.

2. A modified asphalt
which comprises asphalt, an elastomer and a (meth)acrylic resin as essential constituents,
with the ratios of said asphalt, elastomer and (meth)acrylic resin being such that the elastomer accounts for 1 to 10 parts by weight and the (meth)acrylic resin for 0.01 to 15 parts by weight per 100 parts by weight of asphalt.

3. A modified asphalt mixture
which comprises the modified asphalt according to claim 2 and
an aggregate as essential constituents.

4. A pavement method of a modified asphalt
which comprises using the asphalt mixture according to claim 3.

5. A composition
which comprises a styrenic elastomer and a (meth)acrylic resin produced by polymerizing a monomer composition comprising, as essential constituents, a (meth)acrylate of which ester moiety has a cyclohexyl group and a (meth)acrylate of which ester moiety has an alkyl group containing not less than 8 carbon atoms.
